(19) United States
(12) Patent Application Publication
(10) Pub. No.: US 2026/0299506 A1
(43) Pub. Date: Oct. 1, 2026

(54) INTERLOCK MECHANISM AND IMAGE FORMING APPARATUS

(71) Applicant: FUJIFILM Business Innovation Corp., Tokyo (JP)

(72) Inventor: Michiaki YOSHIDA, Kanagawa (JP)

(73) Assignee: FUJIFILM Business Innovation Corp., Tokyo (JP)

(21) Appl. No.: 19/301,185

(22) Filed: Aug. 15, 2025

(30) Foreign Application Priority Data
Mar. 26, 2025 (JP) 2025-052153

(51) Int. Cl. G03G 21/16; G03G 15/00

(52) U.S. Cl. CPC G03G 21/1633; G03G 15/80; G03G 2221/1654; G03G 2221/169

(57) ABSTRACT

An interlock mechanism includes: a switch mounted on a housing, the switch including an actuator, the switch being configured to turn on a power source for a device accommodated in the housing, by the actuator being pushed up; a first protrusion protruding from an inner surface of a first covering part configured to open and close a first side of the housing; a second protrusion protruding from an inner surface of a second covering part configured to open and close a second side of the housing in a direction different from a direction where the first covering part opens and closes the first side; a moving member mounted on the housing so as to move in an up-down direction, the moving member being supported by the first protrusion with the first covering part closed, the moving member, with the first covering part open, being moved to a position below a support position where the moving member is supported by the first protrusion; and a swing member swingably supported by the moving member, the swing member pushing up the actuator by being pushed up by the second protrusion with the second covering part closed, the swing member, with the second covering part open, being away from a push-up position where the swing member pushes up the actuator.

### CROSS-REFERENCE TO RELATED APPLICATIONS

This application is based on and claims priority under 35 USC 119 from Japanese Patent Application No. 2025-052153 filed Mar. 26, 2025.

### BACKGROUND

### (i) Technical Field

The present disclosure relates to an interlock mechanism and an image forming apparatus.

### (ii) Related Art

Japanese Unexamined Patent Application Publication No. 10-162684 discloses an interlock device. In the interlock device, an apparatus body supports an interlock switch, and two door covering parts are supported by mutually substantially orthogonal sides of the apparatus body so as to be opened and closed. Actuators protrude from the respective two door covering parts. The interlock device turns on and off the interlock switch with the actuators. The interlock device further includes a first link member and an activation mechanism part. The first link member is swingably supported on the apparatus body side so as to engage with the interlock switch in a contacting and separating manner. The activation mechanism part includes abutted surfaces with which the respective actuators, which are mutually substantially orthogonally disposed, abut and engage. In addition, the activation mechanism part is attached to the first link so as to allow the first link to swing in an off direction when the abutting between one or both of the actuators and the abutted surfaces is released.

Japanese Unexamined Patent Application Publication No. 2008-37054 discloses an interlock mechanism. The interlock mechanism includes a switch, an activation member, and multiple moving members. The switch, by movement of an activation element in on and off directions, turns on and off a power supply source for an apparatus to which the interlock mechanism is mounted. The activation member is placed in an on position where the activation member moves the activation element of the switch in the on direction by abutting directly or through an interlocking member and turns on the switch, and the activation member is placed in an off position where the activation member turns off the switch. The multiple moving members move the activation member to the on position or to the off position by directly abutting or being directly interlocked with the activation member. The moving members move the activation member to the on position when all the moving members move the activation member toward the on position. In the interlock mechanism, moving directions of the multiple moving members when turning on the switch are all different from the on direction of the activation element of the switch.

### SUMMARY

Aspects of non-limiting embodiments of the present disclosure relate to reducing a component count, compared with a configuration using a biasing member biasing, for turning off a power source, a swing member in the opposite direction from a direction where the swing member that pushes an actuator of a switch is pushed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an interlock mechanism including:
a switch mounted on a housing, the switch including an actuator, the switch being configured to turn on a power source for a device accommodated in the housing, by the actuator being pushed up;
a first protrusion protruding from an inner surface of a first covering part configured to open and close a first side of the housing;
a second protrusion protruding from an inner surface of a second covering part configured to open and close a second side of the housing in a direction different from a direction where the first covering part opens and closes the first side;
a moving member mounted on the housing so as to move in an up-down direction, the moving member being supported by the first protrusion with the first covering part closed, the moving member, with the first covering part open, being moved to a position below a support position where the moving member is supported by the first protrusion; and
a swing member swingably supported by the moving member, the swing member pushing up the actuator by being pushed up by the second protrusion with the second covering part closed, the swing member, with the second covering part open, being away from a push-up position where the swing member pushes up the actuator.

### BRIEF DESCRIPTION OF THE DRAWINGS

Exemplary embodiments of the present disclosure will be described in detail based on the following figures, wherein:

FIG. 1 illustrates, from diagonally above, a rear part of an image forming apparatus including an interlock mechanism according to an exemplary embodiment of the present disclosure;

FIG. 2 illustrates, from diagonally above on the opposite side, the rear part of the image forming apparatus illustrated in FIG. 1;

FIG. 3 is a perspective view of a section taken along line III-III in FIG. 2;

FIG. 4 is an enlarged perspective view of a part indicated by arrow IV in FIG. 3;

FIG. 5 is a front view of FIG. 4;

FIG. 6 is a front view illustrating a state where a second covering part is opened in FIG. 4; and

FIG. 7 is a front view illustrating a state where a first covering part is opened in FIG. 6.

### DETAILED DESCRIPTION

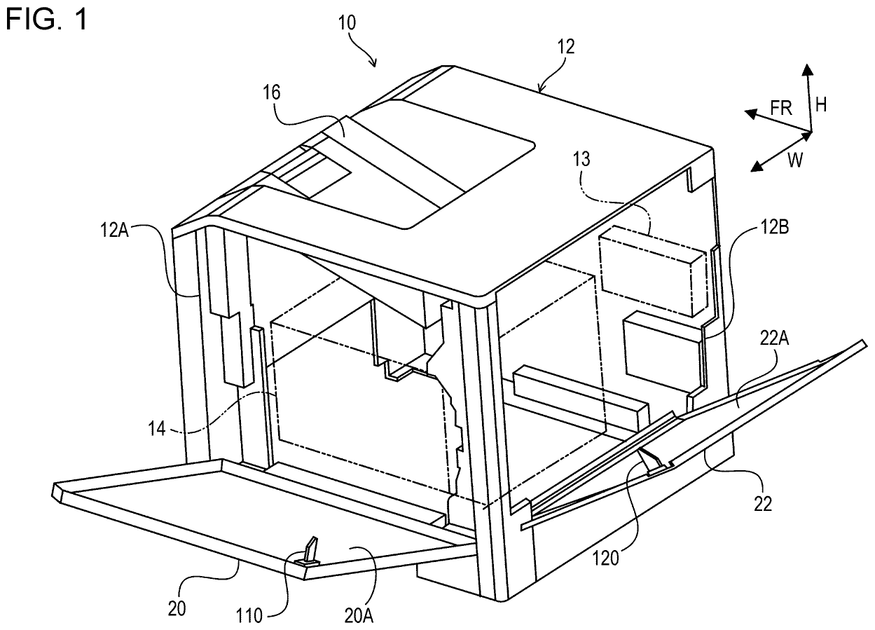

An example of an interlock mechanism and an image forming apparatus according to an exemplary embodiment of the present disclosure will be described with reference to FIGS. 1 to 7. Note that, in each figure, the same or equivalent constituent elements and components are denoted by the same reference signs. In addition, dimensional ratios in the figures may be exaggerated for convenience of description and may differ from the actual ratios.

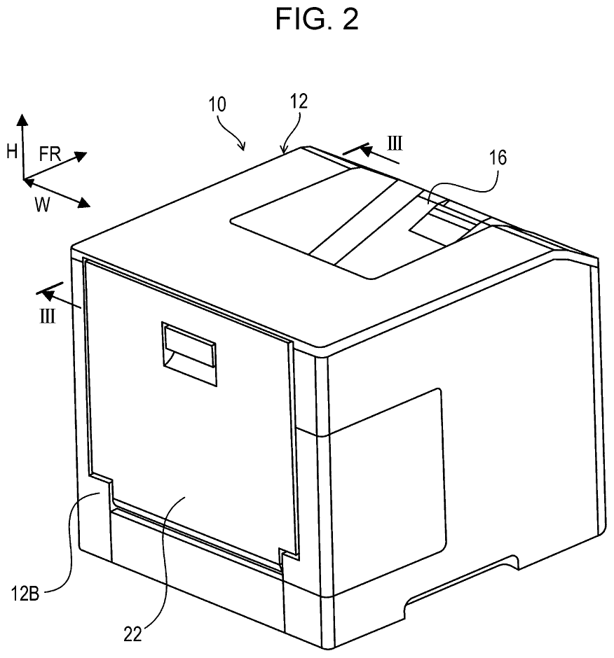

FIG. 1 illustrates an image forming apparatus 10 according to an exemplary embodiment of the present disclosure. The image forming apparatus 10 according to the present disclosure includes, as FIG. 1 illustrates, a housing 12, a power source 13, an image forming unit 14, and an interlock mechanism 15. Note that, in the following description, in the image forming apparatus 10, a side a user using the image forming apparatus 10 mostly faces (the near side in FIG. 1) is referred to as the “front” of the image forming apparatus 10, and the side opposite therefrom (the far side in FIG. 1) is referred to as the “rear” of the image forming apparatus 10. Note that the front of the image forming apparatus 10 is indicated by arrow FR in FIG. 2. In addition, as FIG. 1 illustrates, an up-down direction of the image forming apparatus 10 is indicated by arrow H. Also, a width direction of the image forming apparatus 10 is indicated by arrow W. Note that the width direction of the image forming apparatus 10 may also be referred to as a left-right direction in a case where the user using the image forming apparatus 10 mostly faces the image forming apparatus 10.

The image forming unit 14 that is an example of a device is accommodated inside the housing 12.

The image forming unit 14 is a constituent functioning as a laser printer that prints an image on recording paper by a laser system. As FIG. 1 illustrates, the image forming unit 14 is a device disposed on the lower side in the image forming apparatus 10. The image forming unit 14 includes a toner image forming part, a transfer part that transfers the toner image formed at the toner image forming part onto recording paper, a fixing device that fixes the transferred toner image to the recording paper, and other components, which are not illustrated. Each of the constituents associated with the image forming unit 14 are provided inside the housing 12 and controlled by a controller (not illustrated) based on a print job input by user input operation. The recording paper to which the toner image has been fixed by the image forming unit 14 is output outside the housing 12 from a paper output unit 16.

In addition, the power source 13 that drives the image forming unit 14 is accommodated inside the housing 12.

The housing 12 includes a first covering part 20 configured to open and close a first side 12A of the housing 12. The housing 12 further includes a second covering part 22 configured to open and close a second side 12B of the housing 12. The first side 12A and the second side 12B are different sides of the housing 12. Thus, an opening and closing direction of the first covering part 20 and an opening and closing direction of the second covering part 22 are different.

In the present exemplary embodiment, the first side 12A of the housing 12 is the right side when the housing 12 is viewed from the front. The second side 12B of the housing 12 is the rear side when the housing 12 is viewed from the front. Here, the first side 12A and the second side 12B are mutually adjacent sides. In the present exemplary embodiment, the first side 12A and the second side 12B are mutually orthogonal in one example. Thus, for example, the opening and closing direction of the first covering part 20 and the opening and closing direction of the second covering part 22 are mutually orthogonal when viewed from above.

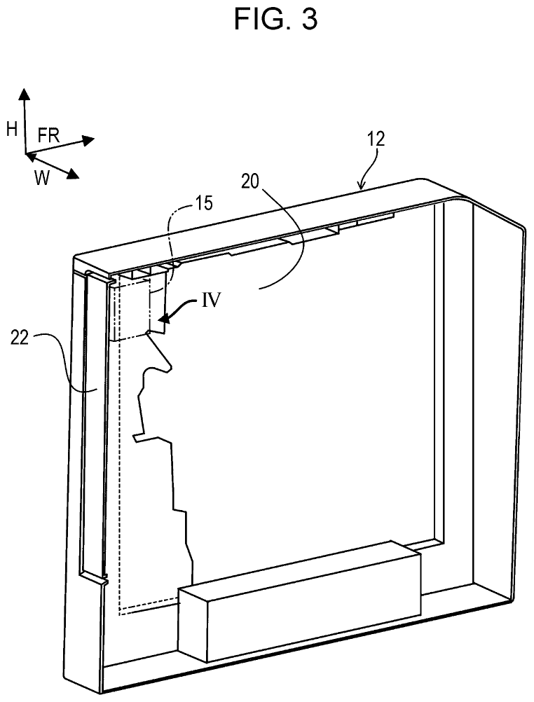

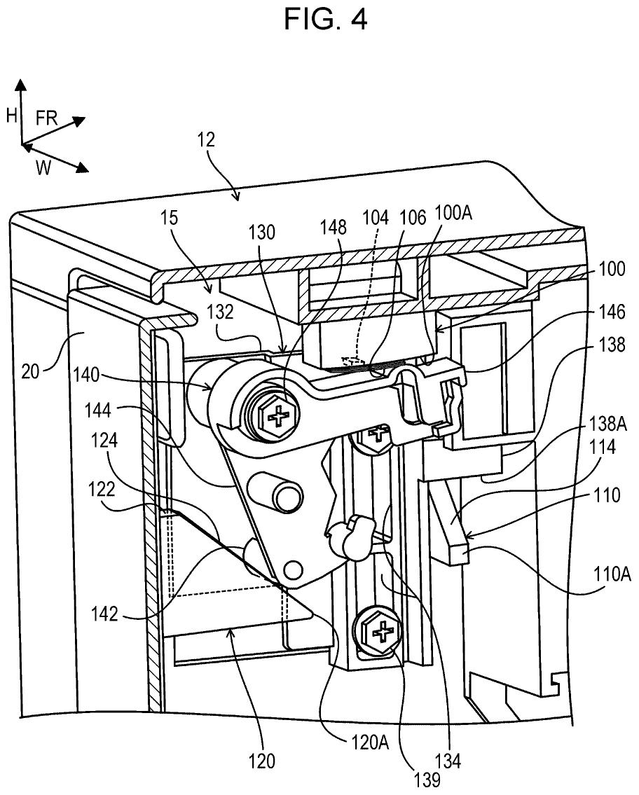

In addition, the interlock mechanism 15 illustrated in FIGS. 3 and 4 is used for the housing 12. The interlock mechanism 15 is a mechanism that stops power supply from the power source 13 to the image forming unit 14 when at least one of the first covering part 20 and the second covering part 22 included in the housing 12 is opened. Note that the power source 13 of the present exemplary embodiment also supplies power to each device provided on or in the housing 12, and power supply to each device is stopped when at least one of the first covering part 20 and the second covering part 22 is opened.

Next, the interlock mechanism 15 of the present exemplary embodiment will be described in detail.

As FIG. 4 illustrates, the interlock mechanism 15 includes a switch 100, a first protrusion 110, a second protrusion 120, a moving member 130, and a swing member 140.

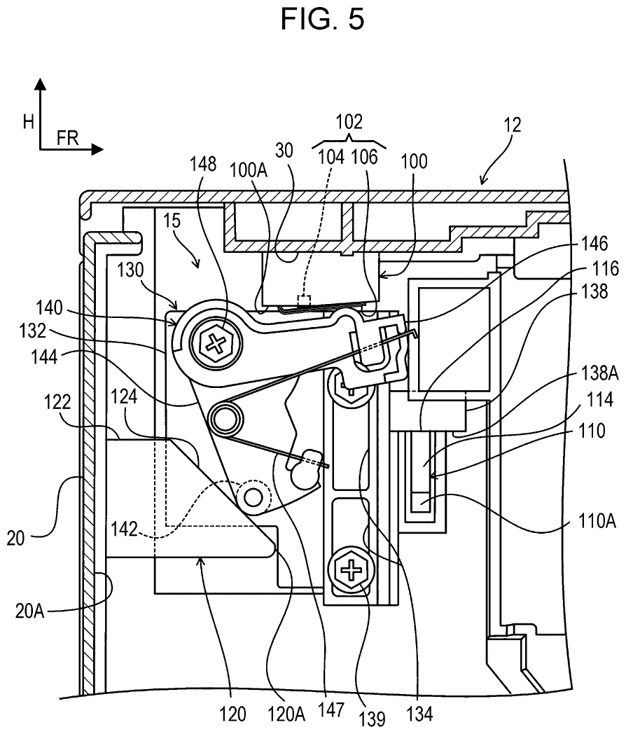

As FIGS. 4 and 5 illustrate, the switch 100 is mounted inside the housing 12. In the present exemplary embodiment, the switch 100 is disposed near a right-side corner portion of a rear part of the housing 12 when the housing 12 is viewed from the front. In addition, the switch 100 is mounted on a bracket 30 provided on a ceiling surface of the housing 12.

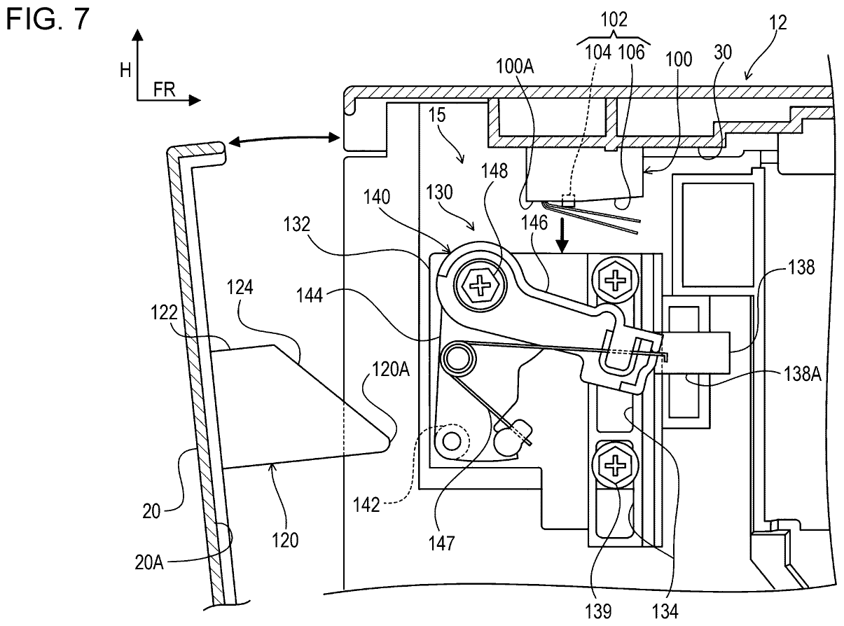

As FIG. 7 illustrates, the switch 100 includes an actuator 102. The actuator 102 includes a push button 104 provided on the switch 100 and a lever 106 for activating the push button 104.

The push button 104 protrudes downward from a lower surface 100A of the switch 100. The push button 104 is pushed up to turn on a contact point of the switch 100, which is not illustrated, and power supply is provided from the power source 13 to the image forming unit 14.

The lever 106 is a metal plate fixed to the lower surface 100A of the switch 100. In the present exemplary embodiment, the lever 106 is constituted by two metal plates. When the swing member 140, which will be described later, pushes up the lever 106, the push button 104 is pushed up, and power supply is provided by the power source 13 to the image forming unit 14. Note that such an on state of the power supply from the power source 13 to the image forming unit 14 can be maintained all the time by keeping pushing up the push button 104.

As FIGS. 1 and 4 illustrate, the first protrusion 110 protrudes from an inner surface 20A of the first covering part 20 configured to open and close the first side 12A of the housing 12. As FIG. 5 illustrates, the first protrusion 110 can support the moving member 130 with the first covering part 20 closed. Note that a position where the moving member 130 is supported by the first protrusion 110 is referred to as a support position of the moving member 130.

As FIG. 5 illustrates, the first protrusion 110 includes a supporting surface 116 supporting a lower surface 138A, of a protrusion 138 of the moving member 130, serving as a supported portion with the first covering part 20 closed. The first protrusion 110 further includes an inclined surface 114 extending diagonally downward from the supporting surface 116 toward a distal end portion 110A of the first protrusion 110 in a protruding direction of the first protrusion 110.

As FIGS. 1 and 4 illustrate, the second protrusion 120 protrudes from an inner surface 22A of the second covering part 22 configured to open and close the second side 12B of the housing 12. As FIG. 5 illustrates, the second protrusion 120 can swing the swing member 140 around a swing center with the second covering part 22 closed. The second protrusion 120 pushes and swings the swing member 140, and the actuator 102 is thereby pushed up. Note that a position where the swing member 140 is swung by the second protrusion 120 and pushes up the actuator 102 is referred to as a push-up position of the swing member 140.

As FIG. 4 illustrates, the second protrusion 120 includes an inclined surface 124 extending diagonally downward from an upper surface 122 toward a distal end portion 120A of the second protrusion 120 in a protruding direction of the second protrusion 120 with the second covering part 22 closed.

As FIGS. 4, 5, and 7 illustrate, the moving member 130 is mounted on the housing 12 so as to move in the up-down direction. In the present exemplary embodiment, the moving member 130 is mounted on an inner surface of a right wall of the housing 12 so as to move in the up-down direction.

The moving member 130 includes a base part 132 and a through hole 134. The base part 132 has a thick plate shape. The through hole 134 is provided in the base part 132. The through hole 134 extends through the base part 132 in a plate thickness direction. In addition, the through hole 134 is an elongated hole whose longitudinal direction is the up-down direction. In the present exemplary embodiment, the base part 132 has two through holes 134 at upper and lower spots.

Through the through holes 134, screw members 139 are screwed in respective screw holes (not illustrated) formed in the inner surface of the right wall of the housing 12. Screw portions of the screw members 139 allow the base part 132 of the moving member 130 to move in the up-down direction. Note that, although the screw member 139 is used in the present disclosure, a protrusion may be provided on the inner surface of the right wall of the housing 12 and, by being passed through the through hole, may allow the moving member 130 to move in the up-down direction. In addition, the screw portion of the screw member 139 may be inserted in a collar (cylindrical body).

The base part 132 of the moving member 130 further includes the protrusion 138. The protrusion 138 is a part supported by the first protrusion 110 with the first covering part 20 closed.

Here, as FIGS. 4 and 5 illustrate, the moving member 130 is supported by the first protrusion 110 with the first covering part 20 closed. Specifically, the lower surface 138A of the protrusion 138 of the moving member 130 is supported by the supporting surface 116 of the first protrusion 110.

With the first covering part 20 open, the moving member 130 is moved to a position below the support position where the moving member 130 is supported by the first protrusion 110. That is, when the first covering part 20 is opened, the first protrusion 110 supporting the moving member 130 is withdrawn, and the moving member 130 thereby moves downward under its own weight along the longitudinal direction of each of the through holes 134. That is, the moving member 130 has moved to a position below the support position.

As FIGS. 4, 5, and 7 illustrate, the swing member 140 is swingably supported by the moving member 130. Specifically, the swing member 140 is swingably supported by the base part 132 of the moving member 130 by using a screw member 148.

As FIGS. 4 and 5 illustrate, with the second covering part 22 closed, the swing member 140 is pushed by the second protrusion 120 and swings around the swing center to push up the actuator 102. Note that a portion, of the swing member 140, pushed by the second protrusion 120 is referred to as a pushed portion 142. A portion, of the pushed portion 142, that is in contact with the inclined surface 124 of the second protrusion 120 curves on a circular arc. Note that, in the present exemplary embodiment, the pushed portion 142 is formed into a circular columnar shape.

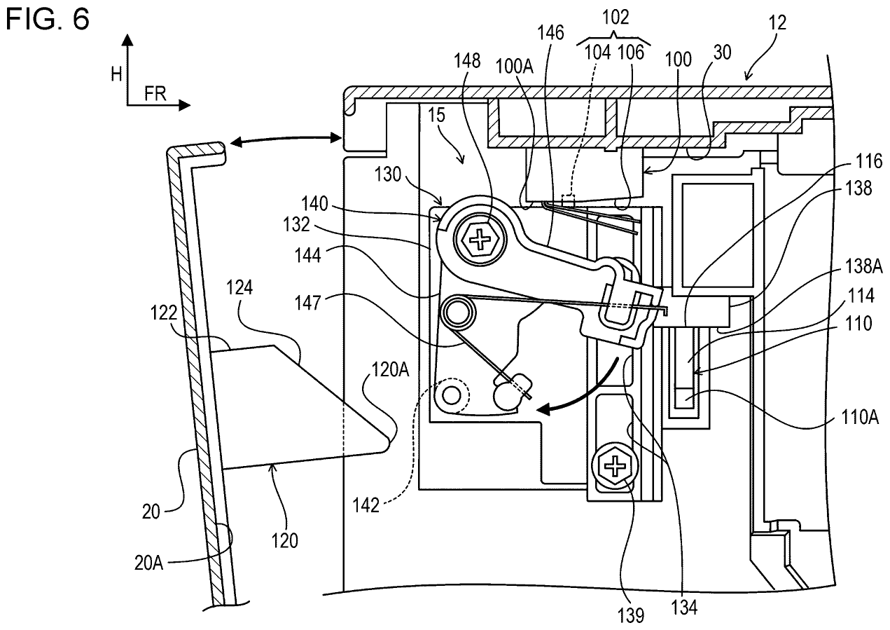

With the second covering part 22 open, as FIG. 6 illustrates, the swing member 140 is away from the push-up position where the swing member 140 pushes up the actuator 102. That is, when the second covering part 22 is opened, the second protrusion 120 pushing the swing member 140 is withdrawn, and the swing member 140 thereby swings under its own weight and moves away from the push-up position.

The swing member 140 of the present exemplary embodiment is constituted by multiple members in one example. Specifically, the swing member 140 includes a first swing member part 144, a second swing member part 146, and a spring material 147. The first swing member part 144 is a plate-shaped member provided with the pushed portion 142. The second swing member part 146 is a plate-shaped member inclined at a predetermined angle relative to the first swing member part 144 with the screw member 148 as the swing center. A distal end portion of the second swing member part 146 pushes up the actuator 102. In addition, the spring material 147 is a spring material for maintaining such an angle constant between the first swing member part 144 and the second swing member part 146 when the screw member 148 serves as the swing center. In the present exemplary embodiment, a coil spring serves as the spring material 147.

Next, actions of the present exemplary embodiment will be described.

In the present exemplary embodiment, as FIGS. 4 and 5 illustrate, the moving member 130 is supported by the first protrusion 110 with the first covering part 20 closed. The swing member 140 pushes up the actuator 102 by being pushed by the second protrusion 120 with the second covering part 22 closed. That is, when the first covering part 20 and the second covering part 22 are both closed, the switch 100 is on, and power is supplied from the power source 13 to the image forming unit 14. Here, as FIG. 6 illustrates, when the second covering part 22 is opened, the swing member 140 swings under its own weight and moves away from the push-up position where the swing member 140 pushes up the actuator 102. Thus, the switch 100 is turned off. In addition, as FIG. 7 illustrates, when the first covering part 20 is opened, the moving member 130 moves under its own weight to a position below the support position. Thus, the switch 100 is turned off. As described above, in the present exemplary embodiment, when at least one of the first covering part 20 and the second covering part 22 is opened, the switch 100 is turned off, and the image forming apparatus 10 comes to a halt. As described above, in the present exemplary embodiment, the component count may be reduced, compared with a configuration, in opening and closing of the covering part, using a biasing member biasing, for turning off the power source, the swing member in the opposite direction from a direction where the swing member that pushes the actuator of the switch is pushed.

In the present exemplary embodiment, the actuator 102 includes the push button 104 at the lower surface and the lever 106 having a plate shape and a spring property and configured to push the push button 104 by being pushed up by the swing member 140. As described above, the present exemplary embodiment may facilitate, with the restoring force of the lever 106, turn-off of the power source with any one of the covering parts open, compared with a configuration where the swing member 140 directly pushes up the push button 104. That is, with the covering part open, turn-off of the switch 100 may be facilitated by using the restoring force of the lever 106 in addition to the own weight of the member.

In the present exemplary embodiment, the first protrusion 110 includes the supporting surface 116 supporting the protrusion 138 of the moving member 130 and includes the inclined surface 114 extending diagonally downward from the supporting surface 116, with the first covering part 20 closed. Thus, in the present exemplary embodiment, a closing operation of the first covering part 20 enables the moving member 130 to move to the support position.

In the present exemplary embodiment, the moving member 130 includes the base part 132 and the through holes 134, and the screw members 139 provided on the housing 12 extend through the through holes 134. Thus, in the present exemplary embodiment, the moving member 130 may be moved in the up-down direction with a simple configuration, compared with a structure using a dedicated component for guiding the moving member 130 in the up-down direction.

In the present exemplary embodiment, the second protrusion 120 includes the inclined surface 124 in contact with the pushed portion 142 of the swing member 140 with the second covering part 22 closed. Thus, in the present exemplary embodiment, a closing operation of the second covering part 22 enables the swing member 140 to move to the push-up position.

In the present exemplary embodiment, the portion, of the pushed portion 142, that is in contact with the inclined surface 124 of the second protrusion 120 curves on a circular arc. Thus, the present exemplary embodiment may cause the swing member 140 to swing to the push-up position smoothly, compared with a configuration where such a portion that is in contact with the inclined surface 124 of the second protrusion 120 is angular.

### Other Exemplary Embodiments

Although the swing member 140 is constituted by multiple components in the interlock mechanism of the above-described exemplary embodiment, the present disclosure is not limited to the configuration. For example, the swing member 140 may be constituted by a single component. That is, a cam member having a circular arc shape may serve as the swing member.

Note that, although the present disclosure has so far been described in detail through specific exemplary embodiments, the present disclosure is not limited to the exemplary embodiments. It will be apparent to the practitioners skilled in the art that various other exemplary embodiments are possible within the scope of the present disclosure.

### Appendix

### (((1)))

An interlock mechanism comprising:
a switch mounted on a housing, the switch including an actuator, the switch being configured to turn on a power source for a device accommodated in the housing, by the actuator being pushed up;
a first protrusion protruding from an inner surface of a first covering part configured to open and close a first side of the housing;
a second protrusion protruding from an inner surface of a second covering part configured to open and close a second side of the housing in a direction different from a direction where the first covering part opens and closes the first side;
a moving member mounted on the housing so as to move in an up-down direction, the moving member being supported by the first protrusion with the first covering part closed, the moving member, with the first covering part open, being moved to a position below a support position where the moving member is supported by the first protrusion; and
a swing member swingably supported by the moving member, the swing member pushing up the actuator by being pushed up by the second protrusion with the second covering part closed, the swing member, with the second covering part open, being away from a push-up position where the swing member pushes up the actuator.

### (((2)))

The interlock mechanism according to (((1))), wherein:
the actuator includes a push button at a lower surface and a lever having a plate shape and a spring property, fixed to the lower surface, and configured to push the push button by being pushed up by the swing member.

### (((3)))

The interlock mechanism according to (((1))) or (((2))), wherein:
the moving member includes a supported portion, and
the first protrusion includes a supporting surface supporting the supported portion of the moving member and includes an inclined surface extending diagonally downward from the supporting surface toward a distal end portion of the first protrusion in a protruding direction of the first protrusion, with the first covering part closed.

### (((4)))

The interlock mechanism according to (((3))), wherein:
the moving member includes a base part and a through hole provided in the base part and extending in the up-down direction, and
a protrusion is provided on the housing and extends through the through hole.

### (((5)))

The interlock mechanism according to (((1))) or (((2))), wherein:
the swing member includes a pushed portion, and
the second protrusion includes an inclined surface in contact with the pushed portion of the swing member and extending diagonally upward from a distal end portion of the second protrusion in a protruding direction of the second protrusion toward a proximal end portion of the second protrusion, with the second covering part closed.

### (((6)))

The interlock mechanism according to (((5))), wherein:
a portion, of the pushed portion, that is in contact with the inclined surface of the second protrusion curves on a circular arc.

### (((7)))

An image forming apparatus comprising:
a housing including a power source and the interlock mechanism according to any one of (((1))) to (((6))); and
an image forming unit accommodated in the housing and configured to form an image on paper with the power source on.

What is claimed is:

1. An interlock mechanism comprising:
a switch mounted on a housing, the switch including an actuator, the switch being configured to turn on a power source for a device accommodated in the housing, by the actuator being pushed up;
a first protrusion protruding from an inner surface of a first covering part configured to open and close a first side of the housing;
a second protrusion protruding from an inner surface of a second covering part configured to open and close a second side of the housing in a direction different from a direction where the first covering part opens and closes the first side;
a moving member mounted on the housing so as to move in an up-down direction, the moving member being supported by the first protrusion with the first covering part closed, the moving member, with the first covering part open, being moved to a position below a support position where the moving member is supported by the first protrusion; and
a swing member swingably supported by the moving member, the swing member pushing up the actuator by being pushed up by the second protrusion with the second covering part closed, the swing member, with the second covering part open, being away from a push-up position where the swing member pushes up the actuator.

2. The interlock mechanism according to claim 1, wherein:
the actuator includes a push button at a lower surface and a lever having a plate shape and a spring property, fixed to the lower surface, and configured to push the push button by being pushed up by the swing member.

3. The interlock mechanism according to claim 1, wherein:
the moving member includes a supported portion, and
the first protrusion includes a supporting surface supporting the supported portion of the moving member and includes an inclined surface extending diagonally downward from the supporting surface toward a distal end portion of the first protrusion in a protruding direction of the first protrusion, with the first covering part closed.

4. The interlock mechanism according to claim 3, wherein:
the moving member includes a base part and a through hole provided in the base part and extending in the up-down direction, and
a protrusion is provided on the housing and extends through the through hole.

5. The interlock mechanism according to claim 1, wherein:
the swing member includes a pushed portion, and
the second protrusion includes an inclined surface in contact with the pushed portion of the swing member and extending diagonally upward from a distal end portion of the second protrusion in a protruding direction of the second protrusion toward a proximal end portion of the second protrusion, with the second covering part closed.

6. The interlock mechanism according to claim 5, wherein:
a portion, of the pushed portion, that is in contact with the inclined surface of the second protrusion curves on a circular arc.

7. An image forming apparatus comprising:
a housing including a power source and the interlock mechanism according to claim 1; and
an image forming unit accommodated in the housing and configured to form an image on paper with the power source on.

8. An image forming apparatus comprising:
a housing including a power source and the interlock mechanism according to claim 2; and
an image forming unit accommodated in the housing and configured to form an image on paper with the power source on.

9. An image forming apparatus comprising:
a housing including a power source and the interlock mechanism according to claim 3; and
an image forming unit accommodated in the housing and configured to form an image on paper with the power source on.

10. An image forming apparatus comprising:
a housing including a power source and the interlock mechanism according to claim 4; and
an image forming unit accommodated in the housing and configured to form an image on paper with the power source on.

11. An image forming apparatus comprising:
a housing including a power source and the interlock mechanism according to claim 5; and
an image forming unit accommodated in the housing and configured to form an image on paper with the power source on.

12. An image forming apparatus comprising:
a housing including a power source and the interlock mechanism according to claim 6; and
an image forming unit accommodated in the housing and configured to form an image on paper with the power source on.
